(19) United States
(12) Patent Application Publication
(10) Pub. No.: US 2006/0054426 A1
(43) Pub. Date: Mar. 16, 2006

(54) Braking apparatus and method of braking

(76) Inventors: Dale A. Fillmore, Huntington, UT (US); Evan W. Fillmore, Huntington, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 11/225,972

(22) Filed: Sep. 13, 2005

Related U.S. Application Data
(60) Provisional application No. 60/609,641, filed on Sep. 13, 2004.

(51) Int. Cl. F16D 55/04

(52) U.S. Cl. 188/71.4

(57) ABSTRACT

Embodiments of the present invention include externally mounted brake actuators, a reverse modulator interface, a wet-disk brake including at least one of the externally mounted brake actuators and a method of braking. Embodiments of the wet-disk brake may be configured as a parking brake, as a service brake or both.

### CROSS-REFERENCE TO RELATED APPLICATIONS

This nonprovisional patent application claims benefit and priority under 35 U.S.C. § 119(e) of the filing of U.S. Provisional Patent Application Ser. No. 60/609,641 filed on Sep. 13, 2004, titled “BRAKING APPARATUS AND METHOD OF OPERATION,” the contents of which are incorporated herein by reference for all purposes.

### BACKGROUND OF THE INVENTION

1. Field of the Invention

The present invention relates generally to braking systems and methods for use with rotating shafts under load. More particularly, this invention relates to a wet-disk braking apparatus including one or more brake actuators that are externally mounted and a method of braking.

2. Description of Related Art

Various conventional braking systems for vehicles are known in the art, including drum brakes, disk brakes and wet-disk brakes. Wet-disk brake systems are particularly useful in harsh environmental conditions such as on industrial vehicles for mining, earth moving, road and building construction and the like.

Conventional wet-disk brakes are generally configured as a sealed mechanism with an internally mounted piston actuator that selectively applies pressure to a pressure plate all within a sealed, wet-disk brake housing. Such conventional wet-disk brakes may be located near hubs on vehicle axles. One disadvantage with conventional wet-disk brakes is that because the entire mechanism is sealed, servicing requires the complete disassembly of the wet-disk brake housing to access the component parts. Another disadvantage with conventional wet-disk brakes located at the hubs of vehicle axles is that the wet-disk brake assembly tends to be bulky because all of the component parts, including the brake actuator is located within the conventional wet-disk brake housing. Thus, conventional wet-disk brakes are too large for placement on many stock vehicles.

Accordingly, there exists a need in the art for a new wet-disk brake apparatus and method of braking that utilizes external actuation, thus providing smaller packaging. It would also be desirable to have a wet-disk brake that has externally mounted actuators to facilitate ease of servicing of the actuator. Another desirable feature would be a wet-disk brake with externally mounted actuators that is capable of both service and parking brake functions. Finally, it would be desirable to have a wet-disk brake system that is scalable for various applications by scaling the number and placement of the external actuators and that can be a bolt-on replacement for conventional brake systems.

### SUMMARY OF THE INVENTION

Embodiments of a brake actuator for a wet-disk brake configured for externally mounting to a wet-disk brake housing according to the present invention are disclosed. Embodiments of a brake including externally mounted brake actuators according to the present invention are also disclosed. One embodiment of a brake includes a yoke having radial splines configured to be fixed on a shaft. The embodiment of a brake further includes a disk pack having teeth configured to engage the radial splines of the yoke. The embodiment of a brake further includes a plurality of brake actuators and a pressure plate mechanically biased against the disk pack and configured to apply pressure against the disk pack according to actuation of the plurality of brake actuators. The embodiment of a brake further includes a brake housing configured for enclosing the yoke, the disk pack and the pressure plate and for externally mounting the plurality of brake actuators for mechanical contact with the pressure plate.

Another embodiment of a brake according to the present invention is disclosed. The embodiment of a brake may include a yoke having radial splines configured to be fixed on a shaft and a disk pack having teeth configured to engage the radial splines of the yoke. The embodiment of a brake may further include a plurality of brake actuators and a pressure plate mechanically biased against the disk pack and configured to apply pressure against the disk pack according to actuation of the plurality of brake actuators. The embodiment of a brake may further include a brake housing configured for enclosing the yoke, the disk pack and the pressure plate and for externally mounting the plurality of brake actuators for mechanical contact with the pressure plate.

An embodiment of a vehicle axle braking system accoridng to the present invention is also disclosed. The embodiment of a vehicle axle braking system may include a vehicle axle and at least one disk pack configured to engage a hub. The embodiment of a vehicle axle braking system may further include at least one brake actuator and at least one pressure plate configured to apply pressure to the at least one disk pack according to actuation of the at least one brake actuator. The embodiment of a vehicle axle braking system may further include at least one brake housing configured for enclosing the at least one disk pack and the at least one pressure plate and for externally mounting the at least one brake actuator for mechanical actuation of the at least one pressure plate.

An embodiment of a vehicle parking brake according to the present invention is also disclosed. The embodiment of vehicle parking brake may include a yoke configured to be fixed on a distal end of a vehicle axle and a plurality of spring-apply, hydraulic-release actuators. The embodiment of vehicle parking brake may further include a pressure plate configured to engage or disengage the yoke according to actuation of the plurality of spring-apply, hydraulic-release actuators. The embodiment, of vehicle parking brake may further include a brake housing configured for enclosing the yolk and pressure plate and for externally mounting the plurality of spring-apply, hydraulic-release actuators for mechanical actuation of the pressure plate.

An embodiment of a method of braking is also disclosed according to the present invention.

### BRIEF DESCRIPTION OF THE SEVERAL VIEWS OF THE DRAWINGS

The following drawings illustrate exemplary embodiments for carrying out the invention. Like reference numerals refer to like parts in different views or embodiments of the present invention in the drawings.

FIG. 1A is an exploded view of a spring-apply hydraulic-release brake actuator according to an embodiment of the present invention.

FIG. 1B is a top view of an assembled actuator according to an embodiment of the present invention.

FIG. 1C is a section view of the assembled actuator 100 as shown by the arrows in FIG. 1B.

FIG. 2 is an exploded view of wet-disk parking brake according to an embodiment of the present invention including three of the actuators shown in FIG. 1.

FIG. 3 is an exploded view of a service and parking brake according to the present invention including at least one of the brake actuators shown in FIG. 1.

FIG. 4 is an exploded view the service and parking brake shown in FIG. 3 as configured for assembly on an axle with a hub according to the present invention.

FIG. 5 illustrates an embodiment of a heavy-duty pickup axle utilizing two of the service and parking brakes assembled according to FIG. 4.

FIG. 6 is a block diagram of a retro-fit brake system according to another embodiment of the present invention.

FIG. 7 is an exploded view of an exemplary embodiment of a reverse modulation interface according to the present invention.

FIG. 8 is a flow chart of an embodiment of a method of braking according to the present invention.

### DETAILED DESCRIPTION OF THE INVENTION

Embodiments of the present invention include externally mounted brake actuators, a wet-disk brake including at least one of the externally mounted brake actuators and a method of braking. Embodiments of the wet-disk brake may be configured as a parking brake, as a service brake or both. Embodiments of the present invention include one or more externally mounted spring-apply hydraulic release brake actuators. These externally mounted or “remote” actuators may be attached outside of a brake housing. Embodiments of the brake according to the present invention may be configured as a parking brake. Other embodiments of the brake according to the present invention may be configured as both a service brake and a parking brake.

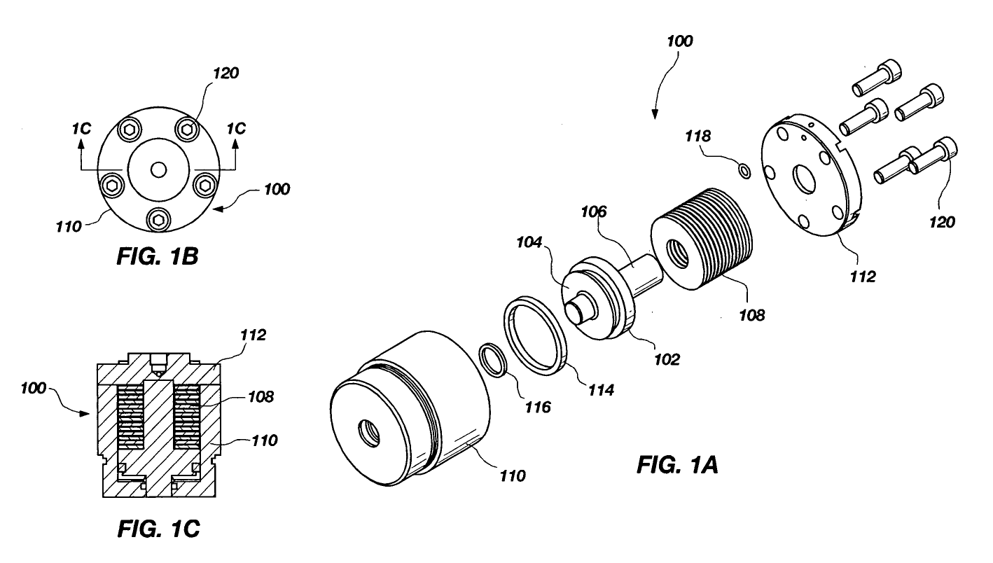

FIG. 1A is an exploded view of a spring-apply hydraulic-release actuator 100 according to an embodiment of the present invention. FIG. 1B is a top view of an assembled actuator 100 according to an embodiment of the present invention. FIG. 1C is a section view of the assembled actuator 100 as shown by the arrows in FIG. 1B. The spring-apply hydraulic-release actuator 100 may include an actuator piston 102 having a head 104 and a shaft 106. The spring-apply hydraulic-release actuator 100 may further include a stack of Belleville springs 108 configured for placement around the shaft 106 of the actuator piston 102. The quantity, force rating and stacking configuration of the Belleville springs used in the stack 108 may be selected according to the requirements of the particular application for the actuator 100 according to various embodiments of the present invention.

The spring-apply hydraulic-release actuator 100 may further include an actuator housing 110 and actuator cap 112 for enclosing the actuator piston 102 and stack of Belleville springs 108. The spring-apply hydraulic-release actuator 100 may further include a piston seal 114, a piston o-ring 116, cap O-rings 118 (only one shown in FIG. 1A) and bolts 120 for assembling and effecting hydraulic seals for the actuator 100.

In operation of the actuator 100, the stack of Belleville springs 108 may be compressed by the application or evacuation of hydraulic fluid within the actuator housing 110 according to embodiments of the present invention. In a preferred embodiment, the stack of Belleville springs 108 may be compressed upon evacuation of hydraulic fluid in order to provide “fail-safe” braking action under loss of hydraulic power.

A distinctive feature of the embodiments of brakes according to the present invention is that the brake actuator is configured for externally mounting to a wet-disk brake housing. Another embodiment of a brake actuator 100 according to the present invention is disclosed. The brake actuator 100 may include an actuator piston 102 having a head 104 and a shaft 106. The brake actuator 100 may further include a stack of Belleville springs 108 configured for placement around the actuator piston 102 shaft 106. The brake actuator 100 may further include an actuator housing 110 configured for containing the actuator piston 102 and the stack of Belleville springs 108. The brake actuator 100 may further include an actuator cap 112 configured for mating with the actuator housing 110 to seal the actuator piston 102 and the stack of Belleville springs 108 within the actuator housing 110. The brake actuator 100 may further include the brake actuator 100 being configured to selectively apply and release a force against a pressure plate (not shown in FIGS. 1A-1C) within the wet-disk brake housing (also not shown in FIGS. 1A-1C).

The brake actuator 100 may be a spring-apply, hydraulic release brake actuator according to an embodiment of the present invention and as illustrated in FIGS. 1A-1C. According to a feature of this embodiment of a spring-apply, hydraulic release brake actuator 100, upon loss of hydraulic pressure, the stack of Belleville springs applies enough force to engage the wet-disk brake. This provides a “fail-safe” feature that allows the brake to be applied even when hydraulic power is lost. However, the spring-apply, hydraulic release brake actuator is not the only type of brake actuator contemplated. Another embodiment of a brake actuator 100 may be a hydraulic brake actuator according to the present invention. Still another embodiment of a brake actuator 100 may be a hydraulic brake actuator with reverse modulation capability in the hydraulic fluid pressure lines.

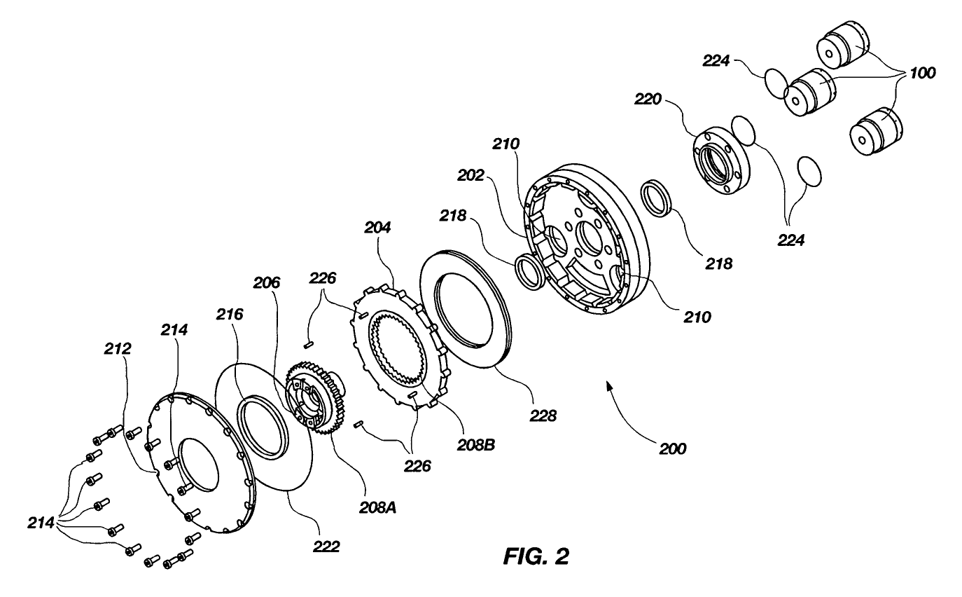

Referring now to FIG. 2, an exploded view of an exemplary embodiment of a wet-disk parking brake 200 according to the present invention is shown. The wet-disk parking brake 200 may include at least one brake actuator 100 (three are shown in FIG. 2). The wet-disk parking brake 200 shown in FIG. 2 may include a brake housing 202, a disk pack 204, a yoke 206 and three brake actuators 100. The brake actuators may be of the spring-apply, hydraulic release variety as illustrated in FIGS. 1A-1C, or of any other suitable brake actuator configuration as long as the brake actuator is capable of external attachment to the brake housing 202 for engaging the pressure plate 228 within the brake housing 202.

Yoke 206 is configured to be fixed to an axle or shaft (not shown in FIG. 2). Yoke 206 may include radiating teeth or splines 208A on an outer circumference that are configured for engaging similar teeth or splines 208B on an inner circumference of the disk pack 204. The wet-disk parking brake 200 may be engaged by the plurality of brake actuators 100 pushing the pressure plate 228 over the yoke 206, thereby engaging the parking brake function. Brake housing 202 may include suitable apertures 210 for receiving externally mounted brake actuators 100.

The wet-disk parking brake 200 shown in FIG. 2 may further include a brake housing end cap 212 and a plurality of end cap bolts 214. The wet-disk parking brake 200 may further include a large face seal 216, small housing seals 218 (two shown in FIG. 2), an input seal housing 220, a large o-ring 222, actuator O-rings 224 (three shown in FIG. 2), a plurality of pressure plate springs 226 (four shown in FIG. 2) and a disk pack 228. Of course one skilled in the art of wet-disk brakes will recognize many variations on the quantities of bolts, O-rings and placement of the component parts for a wet-disk brake. Such variations are considered to be within the scope and spirit of embodiments of the present invention.

Another embodiment of a vehicle parking brake 200 according to the present invention is disclosed. The vehicle parking brake 200 may include a yoke 206 configured to be fixed on a distal end of a vehicle axle (not shown in FIG. 2). The vehicle parking brake 200 may further include a plurality of spring-apply, hydraulic-release actuators 100 (as shown in FIG. 1A-1C and FIG. 2). The vehicle parking brake 200 may further include a disk pack 204 configured to engage or disengage the yoke 206 according to actuation of the plurality of spring-apply, hydraulic-release actuators 100. The vehicle parking brake 200 may further include a brake housing 202 configured for enclosing the yolk 206 and disk pack 204 and for externally mounting the plurality of spring-apply, hydraulic-release actuators 100 for mechanical actuation of the pressure plate 228 against the disk pack 204. The plurality of spring-apply, hydraulic-release actuators 100 may be mounted in appropriately sized apertures 210 in the brake housing 202. According to another embodiment of a vehicle parking brake 200, application of pressure from the actuators 100 against the pressure plate 228 and in turn compressing the disk pack 204 engages the vehicle parking brake 200.

Another embodiment of a brake 200 is also disclosed according to the present invention. The brake 200 may include a yoke 206 configured to be fixed on a shaft (not shown). The brake 200 may include a plurality of brake actuators 100 and a pressure plate 228 configured to engage or disengage the disk pack 204 according to actuation of the plurality of brake actuators 100. The brake 200 may further include a brake housing 202 configured for enclosing the yolk 206, disk pack 204 and pressure plate 228 and for externally mounting the plurality of brake actuators 100 for mechanical contact with the pressure plate 228. According to embodiments of brake 200 each of the plurality of brake actuators 100 may be of any suitable configuration including but not limited to spring-apply, hydraulic release or hydraulic or hydraulic with reverse modulation. The brake 200 may be configured to be mounted on a vehicle axle (not shown in FIG. 2) according to an embodiment of the present invention. The brake 200 may be a parking brake or a service brake or both according to further embodiments of the present invention.

The number and placement of the brake actuators for a given brake application may be selected for any suitable need. While three brake actuators are shown in FIG. 2 at approximately 120° relative spacing along the brake housing 202, other arrangements are also within the scope of the present invention, including a single brake actuator 100. Other embodiments of the brake 200 may include between three and six externally mounted brake actuators 100.

Brake 200 may also be used on any suitable shaft that has a load and needs braking, i.e., angular velocity reduction. For example and not by way of limitation brake 200 may be mounted on a vehicle axle or a drive shaft between a transmission and a differential according to embodiments of the present invention.

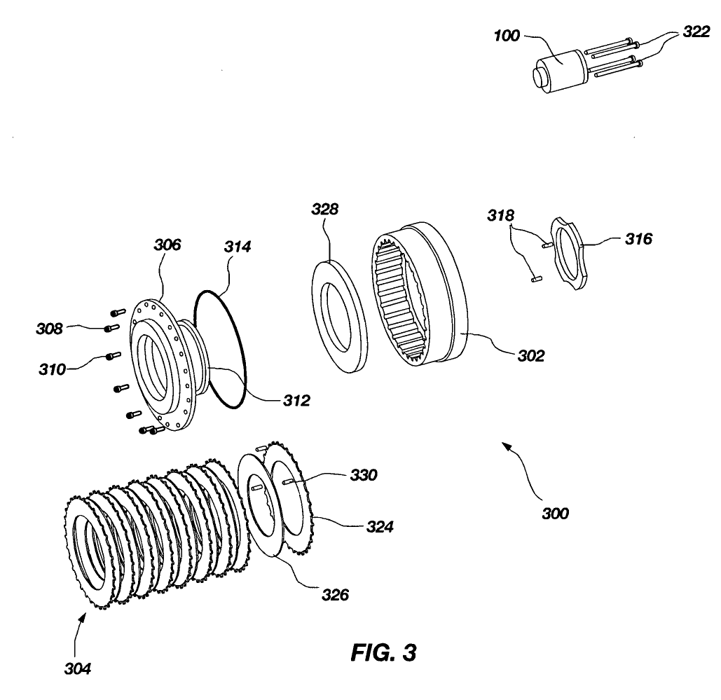

FIG. 3 is an exploded view of a service and parking brake 300 according to the present invention. Service and parking brake 300 may include at least one of the brake actuators 100 shown in FIG. 1. Service and parking brake 300 may further include a brake housing 302, a disk pack, shown generally at 304, a face plate 306, a plurality of face plate bolts 308 and corresponding lock washers 310, an oil seal 312, face plate o-ring 314, a spacer adaptor 316, dowel pins (two shown in FIG. 3), actuator O-rings 320 and actuator mounting bolts 322 (four shown in FIG. 3). The disk pack 304, like disk pack 204, is made up from interlaced reaction disks 324 and friction disks 326 and interspersed disk pack springs 330.

A fixture may be used in conjunction with service and parking brake 300 to engage the hub (not shown in FIG. 3) in a manner similar to the yoke in FIG. 2. Operation of the service and parking brake 300 is similar to the brake 200. Application of the actuator 100 moves the pressure plate 328 against the disk pack 304 creating friction in the disk pack 304 to slow rotation of a hub. Any suitable actuator 100 as describe herein may be used with service and parking brake 300.

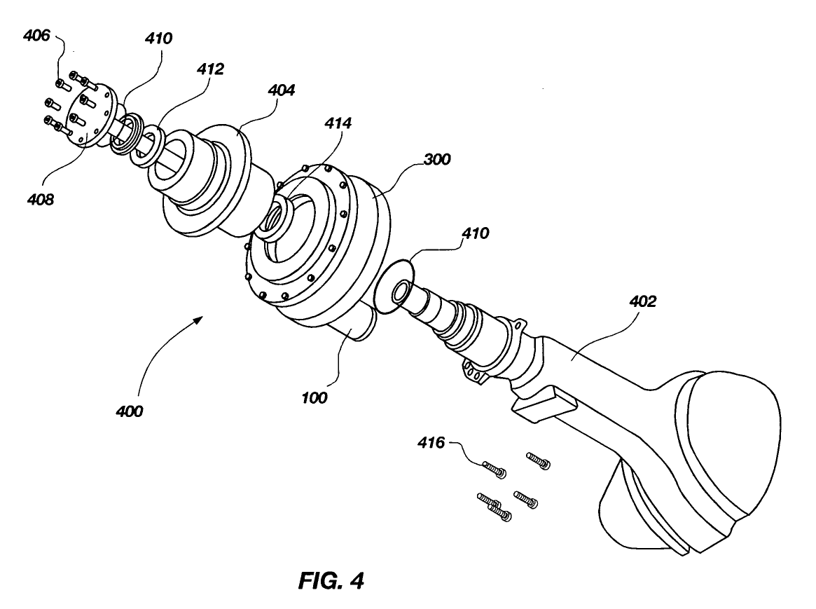

FIG. 4 is an exploded view the service and parking brake 300 shown in FIG. 3 as configured for assembly on an axle 402 with a hub 404 according to the present invention. Also shown in FIG. 4 are hub cap mounting bolts 406, hub end cap 408, o-rings 410 (two shown in FIG. 4), an outer bearing 412, an inner bearing 414, a brake actuator 100 and mounting bolts 416.

An embodiment of a vehicle axle braking system 400 according to the present invention is disclosed. The vehicle axle braking system 400 may include a vehicle axle 402. Vehicle axle 402 may be, for example and not by way of limitation, a Dana 135S axle on a Ford F-550 heavy duty pickup truck. The vehicle axle braking system 400 may further include at least one disk pack 304 configured to engage a hub 404 and at least one brake actuator 100. The vehicle axle braking system 400 may further include at least one pressure plate 328 configured to apply pressure to the at least one disk pack 304 according to actuation of the at least one brake actuator 100. The vehicle axle braking system 400 may further include at least one brake housing 302 configured for enclosing the at least one disk pack 304 and at least one pressure plate 328 and for externally mounting the at least one brake actuator 100 for mechanical actuation of the at least one pressure plate 328.

According to another embodiment of the vehicle axle braking system 400, the at least one brake actuator 100 may be a spring-apply, hydraulic-release actuator as described herein and shown in FIGS. 1A-1C. According to yet another embodiment of the vehicle axle braking system 400, the vehicle axle 402 may be a heavy-duty truck axle, for example and not by way of limitation, a Dana 135S axle on a Ford F-550 heavy duty pickup truck. According to still another embodiment of the vehicle axle braking system 400, each of the at least one brake housings 302 may be configured for externally mounting four brake actuators 100. According to another embodiment of the vehicle axle braking system 400, the vehicle axle braking system 400 may be configured as a parking brake. Alternatively, the vehicle axle braking system 400 may be configured as both a parking brake and a service brake.

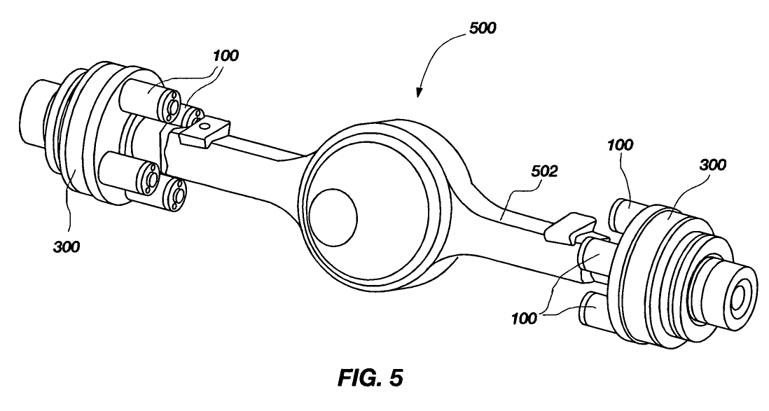

FIG. 5 illustrates an embodiment of a heavy-duty pickup axle 500 utilizing two of the service and parking brakes 300 shown in FIG. 4. The heavy-duty pickup axle 500 may be, for example and not by way of limitation, a Dana 135S axle 502 on a Ford F-550, as shown in FIG. 5. The heavy-duty pickup axle 500 shown in FIG. 5 also utilizes the remote outside package mounting of the brake actuators 100 (four per wheel as shown in FIG. 5). The quantity of brake actuators 100 utilized in a given brake system may range from one up to any suitable number depending of the application and size of the brake system. An advantage of the above embodiments of the present brake system is that they lend themselves to unique packaging and size constraints.

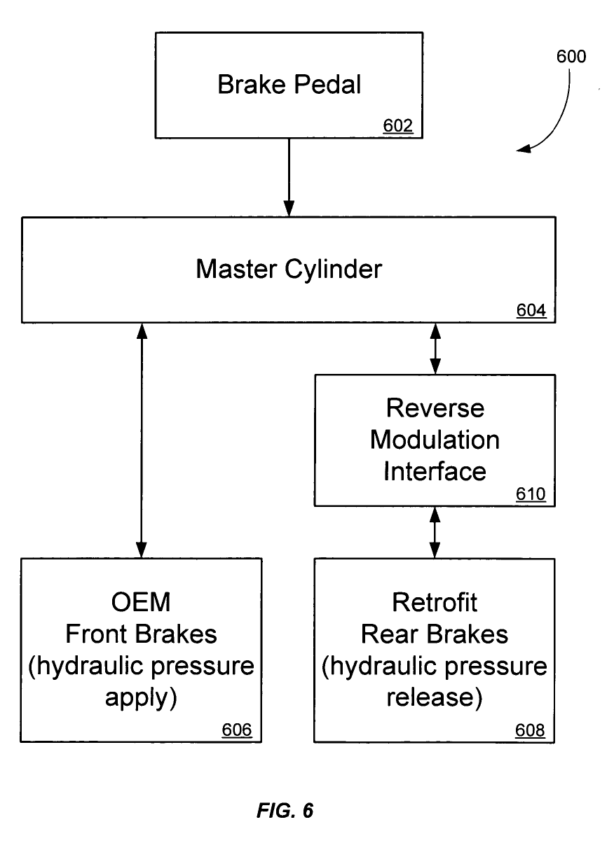

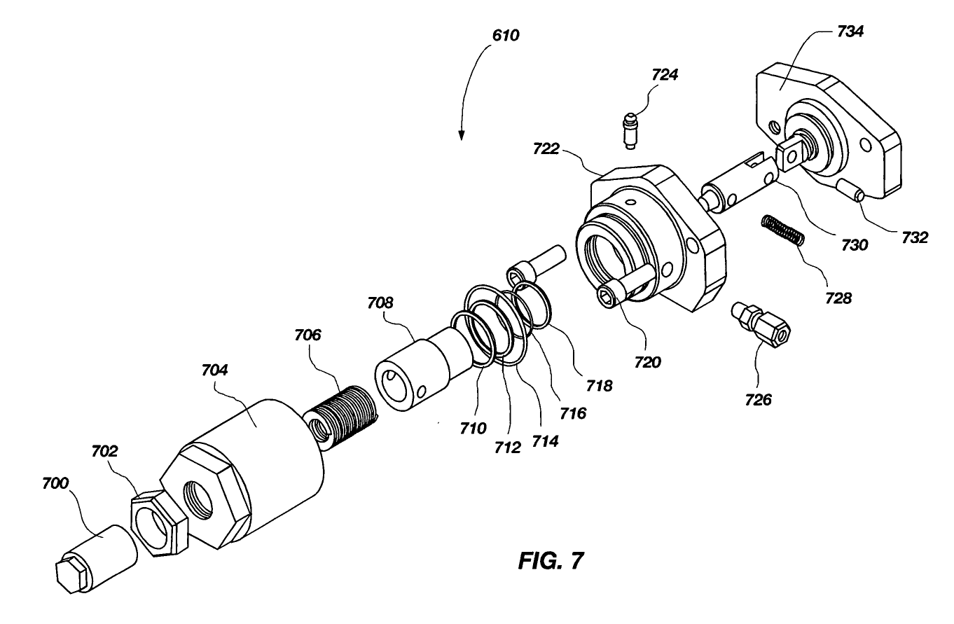

FIG. 6 is a block diagram of a retro-fit brake system 600 according to another embodiment of the present invention. Retro-fit brake system 600 may include a brake pedal 602 in communication with a master cylinder 604. The brake pedal 602 and master cylinder 604 may be from any suitable vehicle. Retro-fit brake system 600 may further include front brakes 606 and rear brakes 608. Front brakes 606 may be the original equipment manufacturer (OEM) brakes installed on the vehicle. Rear brakes 608 may be hydraulic pressure release brakes, such as brakes 200 and 300 described herein. As shown in FIG. 6, a reverse modulation interface 610 is in line between the master cylinder 604 and the retrofit rear brakes 608. Conventional OEM front brakes 606 are applied under hydraulic pressure. Conversely, retrofit rear brakes 608 are applied by evacuating (vacuum) the hydraulic fluid to engage the rear brakes 608. Thus, reverse modulation interface 610 converts positive pressure from the master cylinder into a vacuum of hydraulic fluid at the rear brake 608 and vice versa. An exemplary embodiment of a reverse modulation interface 610 is shown in FIG. 7 and further detailed below.

Yet another embodiment of the vehicle axle braking system 400, may further include a reverse modulation interface 610 (FIG. 6) including a reverse modulating valve (see FIG. 7 and related discussion below) for retrofitting hydraulic pressure apply brakes 608 into the vehicle axle braking system 400. According to an embodiment of vehicle axle braking system 400, the reverse modulation interface 610 may be configured for in line placement on a hydraulic line between the master cylinder 604 and the at least one brake actuator 100. This embodiment of vehicle axle braking system 400, may further include the reverse modulation interface 610 configured to convert hydraulic pressure applied from the master cylinder 610 and output hydraulic vacuum applied and vice versa.

FIG. 7 is an exploded view of an exemplary embodiment of a reverse modulation interface 610 according to the present invention. Reverse modulation interface 610 may include a spring stud 700, a jam nut 702, a spring housing 704, a spring 706, a piston 708, a Teflon® b-ring 710, an o-ring 712, an o-ring 714, an o-ring 716, a Teflon® b-ring 718, allen bolts 720 (two shown in FIG. 7), cylinder 722, bleeder 724, weatherhead 726, long pull pin 728, pull clevis 730, short pull pin 732 and a reverse modulating valve 734 all assembled according to FIG. 7. Reverse modulating valve 734 may be a Mico Part No. 20100625 or any other suitable reverse modulating valve 734.

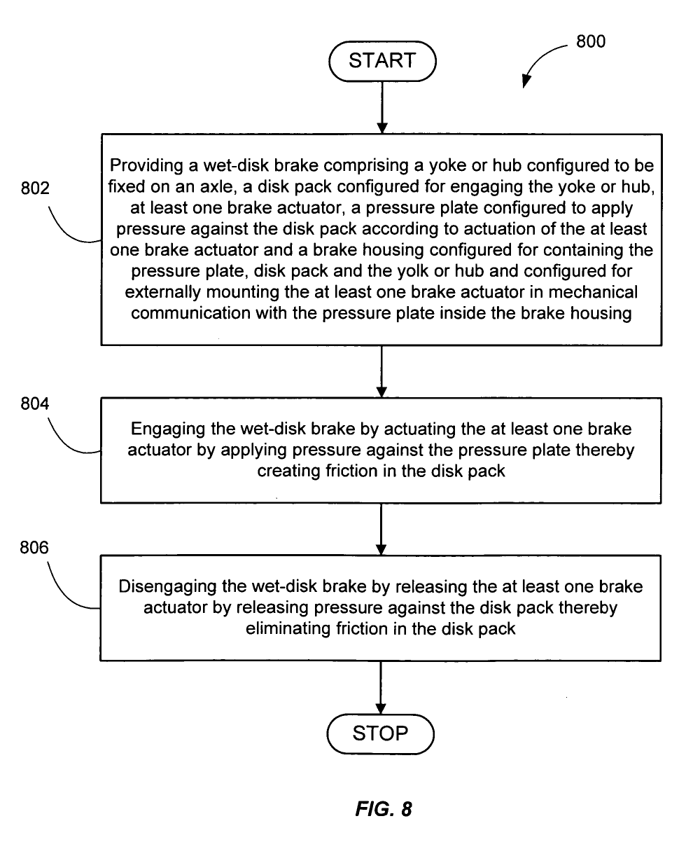

FIG. 8 is a flow chart of an embodiment of a method 800 of braking according to the present invention. Method 800 may include providing 802 a wet-disk brake 200, 300 as described herein. Method 800 may further include engaging 804 the wet-disk brake by actuating one or more brake actuators by applying pressure against the pressure plate thereby creating friction in the disk pack. Method 800 may further include disengaging 806 the wet-disk brake by releasing the one or more brake actuators by releasing pressure from the pressure plate and consequently against the disk pack thereby eliminating friction in the disk pack. According to an embodiment of method 800, providing a wet-disk brake 802 may include providing at least one spring-apply, hydraulic release brake actuator 100 as described herein and shown in FIGS. 1A-1C.

While the foregoing advantages of the present invention are manifested in the illustrated embodiments of the invention, a variety of changes can be made to the configuration, design and construction of the invention to achieve those advantages. Hence, reference herein to specific details of the structure and function of the present invention is by way of example only and not by way of limitation.

What is claimed is:

1. A brake actuator for a wet-disk brake configured for externally mounting to a wet-disk brake housing.

2. The brake actuator according to claim 1, further comprising:
an actuator piston having a head and a shaft;
a spring configured for placement around the actuator piston shaft;
an actuator housing configured for containing the actuator piston and the spring;
an actuator cap configured for mating with the actuator housing to seal the actuator piston and the spring within the actuator housing; and
wherein the brake actuator is configured to selectively apply and release a force against a pressure plate within the wet-disk brake housing.

3. The brake actuator according to claim 2, wherein the spring comprises a stack of Belleville springs.

4. The brake actuator according to claim 2, further comprising a spring-apply, hydraulic release brake actuator.

5. The brake actuator according to claim 4, further configured with a fail-safe feature whereupon loss of hydraulic pressure, the spring applies enough force to engage the wet-disk brake.

6. The brake actuator according to claim 1, further comprising a hydraulic-apply, spring-release brake actuator.

7. The brake actuator according to claim 1, further comprising a hydraulic brake actuator with or without reverse brake valve modulation.

8. A brake, comprising:
a yoke having radial splines configured to be fixed on a shaft;
a disk pack having teeth configured to engage the radial splines of the yoke;
a plurality of brake actuators;
a pressure plate mechanically biased against the disk pack and configured to apply pressure against the disk pack according to actuation of the plurality of brake actuators; and
a brake housing configured for enclosing the yoke, the disk pack and the pressure plate and for externally mounting the plurality of brake actuators for mechanical contact with the pressure plate.

9. The brake according to claim 8, wherein each of the plurality of brake actuators is selected from the group consisting of: spring-apply, hydraulic release, hydraulic and hydraulic with reverse modulation.

10. The brake according to claim 8, wherein the brake is configured to be mounted on a vehicle axle.

11. The brake according to claim 8, wherein the brake comprises a parking brake.

12. The brake according to claim 8, wherein the brake comprises both a service brake and a parking brake.

13. The brake according to claim 8, wherein the plurality of brake actuators comprises between three and six externally mounted brake actuators.

14. The brake according to claim 8, wherein the shaft comprises a vehicle axle.

15. The brake according to claim 8, wherein the yoke is configured to be fixed to a drive shaft between a transmission and a differential.

16. A vehicle axle braking system, comprising:
a vehicle axle;
at least one disk pack configured to engage a hub;
at least one brake actuator;
at least one pressure plate configured to apply pressure to the at least one disk pack according to actuation of the at least one brake actuator; and
at least one brake housing configured for enclosing the at least one disk pack and the at least one pressure plate and for externally mounting the at least one brake actuator for mechanical actuation of the at least one pressure plate.

17. The vehicle axle braking system according to claim 16, wherein the at least one brake actuator comprises a spring-apply, hydraulic-release actuator.

18. The vehicle axle braking system according to claim 16, wherein the vehicle axle comprises a heavy-duty truck axle.

19. The vehicle axle braking system according to claim 16, wherein each of the at least one brake housings is configured for externally mounting four of the at least one brake actuators.

20. The vehicle axle braking system according to claim 16, wherein the vehicle axle braking system comprises a parking brake.

21. The vehicle axle braking system according to claim 16, wherein the vehicle axle braking system comprises a parking brake and a service brake.

22. The vehicle axle braking system according to claim 16, further comprising:
a reverse modulation interface including a reverse modulating valve for retrofitting hydraulic pressure apply brakes into the vehicle axle braking system;
wherein the reverse modulation interface is configured for in line placement on a hydraulic line between a master cylinder and the at least one brake actuator; and
wherein the reverse modulation interface converts hydraulic pressure applied from the master cylinder and outputs hydraulic vacuum applied and vice versa.

23. A vehicle parking brake, comprising:
a yoke configured to be fixed on a distal end of a vehicle axle;
a plurality of spring-apply, hydraulic-release actuators;
a pressure plate configured to engage or disengage the yoke according to actuation of the plurality of spring-apply, hydraulic-release actuators; and
a brake housing configured for enclosing the yolk and pressure plate and for externally mounting the plurality of spring-apply, hydraulic-release actuators for mechanical actuation of the pressure plate.

24. The vehicle parking brake according to claim 23, wherein the yoke and the pressure plate are configured to be selectively coplanar and thereby halting rotation of the pressure plate during application of the vehicle parking brake.

25. A method of braking, comprising: providing a wet-disk brake comprising:
a yoke or hub configured to be fixed on an axle;
a disk pack configured for engaging the yoke or hub;
at least one brake actuator;
a pressure plate configured to apply pressure against the disk pack according to actuation of the at least one brake actuator; and
a brake housing configured for containing the pressure plate, disk pack and the yoke or hub and configured for externally mounting the at least one brake actuator in mechanical communication with the pressure plate inside the brake housing;
engaging the wet-disk brake by actuating the at least one brake actuator by applying pressure against the pressure plate thereby creating friction in the disk pack; and
disengaging the wet-disk brake by releasing the at least one brake actuator by releasing pressure against the pressure plate thereby eliminating friction in the disk pack.

26. The method of braking according to claim 25, wherein providing a wet-disk brake comprises providing at least one spring-apply, hydraulic release brake actuator.
